(19) United States
(12) Patent Application Publication
(10) Pub. No.: US 2013/0330050 A1
(43) Pub. Date: Dec. 12, 2013

(54) BEND-INSENSITIVE OPTICAL FIBER HAVING SMALL COATING DIAMETER AND OPTICAL CABLE COMPRISING THE SAME

(71) Applicants: Eun-Jeong Yang, Seoul (KR); Ji-Sang Park, Seoul (KR)

(72) Inventors: Eun-Jeong Yang, Seoul (KR); Ji-Sang Park, Seoul (KR)

(73) Assignee: LS CABLE & SYSTEM LTD., Anyang-si, Gyeonggi-do (KR)

(21) Appl. No.: 13/985,319

(22) PCT Filed: Feb. 14, 2012
(86) PCT No.: PCT/KR2012/001104

§ 371 Date: Aug. 14, 2013

(30) Foreign Application Priority Data
Feb. 15, 2011 (KR) 10-2011-0013268

(51) Int. Cl. G02B 6/036

(52) U.S. Cl. CPC G02B 6/03694
USPC 385/100; 385/128

(57) ABSTRACT

Provided is a bend-insensitive optical fiber including a core centered at the optical fiber, a cladding surrounding the core and having a lower refractive index than the core, a coating layer surrounding the cladding, and a region formed in the cladding and having a lower refractive index than the cladding, wherein the coating layer has a multilayered structure and a total outer diameter of 240 μm or less, and a bend-insensitive optical cable comprising the same.

### TECHNICAL FIELD

### Cross-Reference to Related Application

This application claims priority from Korean Patent Application No. 10-2011-0013268, filed on Feb. 15, 2011, the entire disclosure of which is incorporated herein by reference for all purposes.

The present invention relates to a bend-insensitive optical fiber and an optical cable, and more particularly, to a bend-insensitive optical fiber having a low bending loss through the improvement in internal structure and material properties, and an optical cable comprising the same.

### BACKGROUND ART

An optical fiber has optical properties that vary depending on the refractive index profile of a core and a cladding, and generally, an optical fiber having desired properties may be fabricated by controlling the refractive index profile.

When compared with other media for data transmission such as a copper line, an optical fiber is advantageous in terms of loss and bandwidth, but is disadvantageous in that it is difficult to handle.

In particular, a conventional optical fiber applied to fiber to the home (FTTH) exhibits a high bending loss as a result of a small bend, and thus, is difficult to install close to the corner or makes it awkward to use an organizer having a small bend diameter. Moreover, a dense wavelength division multiplexing (DWDM) system or a coarse wavelength division multiplexing (CWDM) system generally uses 1550 nm wavelength and also uses 1600 nm wavelength, however when a conventional optical fiber suitable for 1550 nm wavelength is applied at 1600 nm wavelength, mode field diameter (MFD) and bending loss increase. To prevent the deterioration in transmission characteristics caused by the increased loss, there is a need to make the bending loss at 1600 nm wavelength equal to or less than that of 1550 nm wavelength.

With bending loss becoming an issue, interests to improve the structure of an optical fiber to reduce the bending loss are increasing.

A conventional single-mode optical fiber (SMF) needs to reduce an MAC to improve its structure based on a step index (SI) structure. The MAC is a ratio of MFD to cutoff wavelength, and is closely associated with the refractive characteristics of an optical fiber. The smaller the MAC, the more the bending loss of an optical fiber tends to improve.

In the case of an SI optical fiber, the bending loss is improved by reducing an MAC. Disadvantageously, there is a difference in MFD between the SI optical fiber and a conventional optical fiber, resulting in incompatibility.

One example of optical fibers with improved SI structure is a depressed index optical fiber, in which an inner cladding adjacent to a core has a reduced index. The depressed index optical fiber is mainly manufactured by an outside vapor deposition (OVD) process, in particular, a vapor axial deposition (VAD) process.

Another example of optical fibers with improved SI structure is an optical fiber having a trench index profile, in which an index of an inner cladding is similar to that of an outer cladding and an index reduction position is spaced away at a proper distance from a core. The trench index optical fiber has a more complex structure than a conventional step index optical fiber or depressed index optical fiber, and thus is manufactured by an inside vapor deposition process rather than an outer vapor deposition process for easier index control.

Generally, it is known that a depressed index optical fiber has a limitation in improving the bending loss and thus its bendable diameter is limited to about 7.5 mm. To solve this problem, studies have been actively made on a trench index optical fiber having higher possibility of improvement in bending loss than a depressed index optical fiber.

For example, U.S. Pat. No. 7,440,663, U.S. Pat. No. 7,450,807, US 2007/0280615, JP 2009-038371, JP 2008-233927, U.S. Pat. No. 7,505,660, and WO 08/157341 are mentioned.

Specifically, U.S. Pat. No. 7,440,663 and U.S. Pat. No. 7,450,807 relate to a trench index optical fiber and suggest the conditions of a trench such as depth, location, and the like.

US 2007/0280615 also relates to a trench index optical fiber, and proposes a fluorine doping technique using plasma to form a trench structure.

JP 2009-038371 and JP 2008-233927 disclose formation of holes in a cladding to build a trench structure, thereby improving the bending loss. However, these arts have a reduction in productivity due to a hole forming process, and are evaluated as being unsuitable for mass production.

U.S. Pat. No. 7,505,660 aims to ensure productivity by using the hole assisted fiber design, and teaches the creation of bubbles in a cladding to form holes. However, the bubbles are random which results in non-uniform bending characteristics in the lengthwise direction and the circumferential direction of an optical fiber. Also, the mechanical reliability has to be ensured.

WO 08/157341 relates to a ring-assisted fiber and suggests an index profile including a barrier layer in a trench structure to strip off the higher order modes. The trench structure is deep in order to improve the bending loss and strip off the higher order modes, which consequently suppresses the cutoff from increasing. However, this art has a complex index profile, which makes it difficult to ensure reproducibility and is unfavorable for mass production.

To improve the bending characteristics of an optical fiber, attempts have been recently made to improve the resin material properties of a coating layer formed on a cladding. FIG. 1 illustrates a main structure of an optical fiber including a core 11 centered at the optical fiber, a cladding 12 surrounding the core 11, and a coating layer 13 formed on the cladding 12.

Generally, the resin material properties of the coating layer 13 are improved by controlling the modulus of the coating layer 13. Also, the dimension of the coating layer 13 is an important design factor. Typically, the cladding 12 has an outer diameter of 125 μm and the coating layer 13 has an outer diameter of 250 μm. However, this optical fiber structure is not suitable for a multicore optical cable being in demand these days, and increases the manufacturing cost of an optical cable.

### DISCLOSURE OF INVENTION

### Technical Problem

It is an object of the present invention to provide a bend-insensitive optical fiber with a small coating diameter to improve the bending loss characteristics and minimize the volume, and an optical cable comprising the same.

### Solution to Problem

To achieve the object, the present invention provides a bend-insensitive optical fiber including a core centered at the optical fiber, a cladding surrounding the core and having a lower refractive index than the core, a coating layer surrounding the cladding, and a region formed in the cladding and having a lower refractive index than the cladding, wherein the coating layer includes a primary coating layer formed on the cladding and a secondary coating layer formed on the primary coating layer and having a higher modulus than the primary coating layer, and the coating layer has a total outer diameter of 240 μm or less, the primary coating layer has a modulus of 10 MPa or less at room temperature and the secondary coating layer has a modulus of 50 to 1000 MPa at room temperature, and the coating layer has a degree of cure of 90% or more measured by sol-gel analysis.

In another aspect of the present invention, the bend-insensitive optical fiber may include a core centered at the optical fiber, a cladding surrounding the core and having a lower refractive index than the core, a coating layer with a multilayered structure surrounding the cladding and having a total outer diameter of 240 μm or less, and a region formed in the cladding and having a lower refractive index than the cladding, wherein the optical fiber has a microbending loss of 0.02 dB/km or less at 1550 wavelength at room temperature, measured by basket weave testing, the optical fiber has a bidirectional splice loss of 0.1 dB/km or less, the optical fiber has a stress corrosion parameter (Nd) of 18 or more, and the optical fiber has an increase in loss of 0.05 dB/km or less at temperature between −60° C. and 85° C. relative to room temperature.

In still another aspect of the present invention, the bend-insensitive optical fiber may include a core centered at the optical fiber, a cladding surrounding the core and having a lower refractive index than the core, a coating layer surrounding the cladding, and a region formed in the cladding and having a lower refractive index than the cladding, wherein the coating layer has a multilayered structure and a total outer diameter of 240 μm or less.

Preferably, the coating layer has an outer diameter of 200 to 240 μm.

The coating layer may include a primary coating layer formed on the cladding and a secondary coating layer formed on the primary coating layer and having a higher modulus than the primary coating layer.

Preferably, the primary coating layer has a modulus of 10 MPa or less at room temperature, and the secondary coating layer has a modulus of 50 to 1000 MPa at room temperature.

Preferably, a ratio of r1/r2 is 1 to 1.5 where r1 is the thickness of the primary coating layer and r2 is the thickness of the secondary coating layer.

Preferably, the primary coating layer has a glass transition temperature Tg of −30° C. or less and the secondary coating layer has a glass transition temperature Tg of 50° C. or more.

Preferably, the optical fiber has a microbending loss of 0.02 dB/km or less at 1550 nm wavelength at room temperature, measured by basket weave testing.

Preferably, the optical fiber has a multi-path interference (MPI) level of −30 dB or less at 1310 nm, 1550 nm, and 1625 nm wavelength.

Also, the present invention provides a bend-insensitive optical cable comprising the bend-insensitive optical fiber.

### Advantageous Effects of Invention

The bend-insensitive optical fiber with a small coating diameter may improve the bending loss characteristics and minimize the volume. Accordingly, a multicore optical cable may be implemented and the manufacturing cost may be reduced.

### BRIEF DESCRIPTION OF DRAWINGS

The accompanying drawings illustrate a preferred embodiment of the present disclosure and, together with the foregoing disclosure, serves to provide further understanding of the technical spirit of the present disclosure. However, the present disclosure is not to be construed as being limited to the drawings.

FIG. 1 is an exploded perspective view illustrating a structure of a conventional optical fiber.

FIG. 2 is a cross-sectional view illustrating a bend-insensitive optical fiber according to the present invention.

FIG. 3 is a graph illustrating a trench index profile applicable to the present invention.

FIG. 4 is a cross-sectional view illustrating an optical cable with a bend-insensitive optical fiber according to the present invention and an optical cable with a conventional optical fiber for size comparison.

FIG. 5 is a graph illustrating the microbending characteristics evaluation results of a bend-insensitive optical fiber according to an exemplary embodiment of the present invention and a conventional optical fiber.

FIG. 6 is a table illustrating the microbending characteristics at room temperature and the mechanical characteristics depending on the ratio r1:r2 and the modulus of primary and secondary coating layers.

FIG. 7 is a table illustrating the microbending characteristics at room temperature for an optical fiber with a small coating diameter of 240 μm or less.

FIG. 8 is a table illustrating the bidirectional splice loss for an optical fiber with a small coating diameter of 240 μm or less.

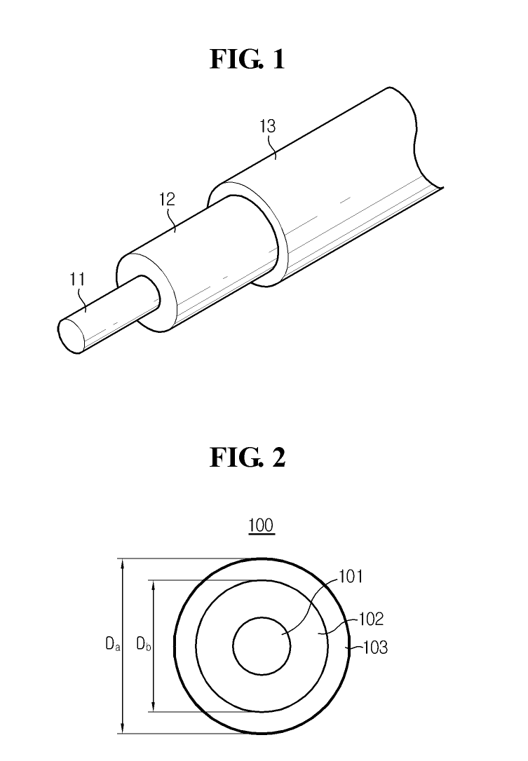

### MODE FOR THE INVENTION

Hereinafter, the present invention will be described in detail. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation.

FIG. 2 is a cross-sectional view illustrating a bend-insensitive optical fiber according to a preferred embodiment of the present invention.

Referring to FIG. 2, a bend-insensitive optical fiber 100 according to a preferred embodiment of the present invention includes a core 101, a cladding 102, and a coating layer 103 having an outer diameter Dₐ of 240 μm or less. Here, the present invention is not limited to a specific thickness ratio between the core 101, the cladding 102, and the coating layer 103 disclosed and illustrated herein.

The core 101 is centered at the optical fiber 100 and the cladding 102 surrounds the core 101. The cladding 102 has a lower refractive index than that of the core 101 and preferably has an outer diameter Dₐ of about 125 μm.

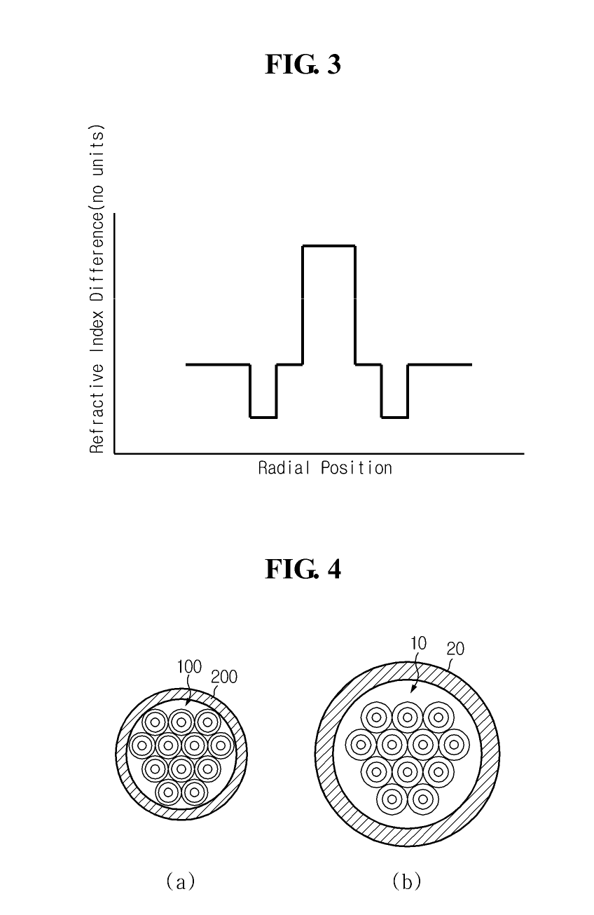

The cladding 102 is provided with a region having a lower refractive index than that of the cladding 102. The region preferably has a trench structure, however the present invention is not limited in this regard. The trench region provides a trench index profile, in which as shown in FIG. 3.

In the bend-insensitive optical fiber 100, the trench region in the cladding 102 has a bending loss of 0.02 dB/km at 1550 nm. In this instance, the microbending characteristics are measured by basket weave testing. The basket weave testing is one of the microbending loss test methods in accordance with the TIA/EIA TSB 62-13 standards, and carried out to measure a microbending loss, that is, a difference in loss at 1550 nm between when an optical fiber of 2.5 km length is wound on a quartz bobbin having the same characteristics as those of the optical fiber under predetermined tension and linear velocity conditions and when the optical fiber is generally wound on a spool. For reference, when the bend-insensitive optical fiber 100 has an SI structure, the bend-insensitive optical fiber 100 has a microbending loss of 0.02 dB/km or less at 1550 nm when measured by basket weave testing.

The coating layer 103 includes a primary coating layer formed on the cladding 102 and a secondary coating layer formed on the primary coating layer. To improve the bending characteristics of the optical fiber and meet the demand for minimization as well, the coating layer 103 is designed to have a final outer diameter, that is, the total outer diameter Dₐ of about 240 μm or less. Generally, if the outer diameter of the coating layer 103 is too small, it is difficult to protect the optical fiber from external impacts, and the transmission loss dramatically increases under severe conditions. Accordingly, the coating layer 103 preferably has an outer diameter Dₐ between 200 μm and 240 μm.

In the coating layer 103, the primary coating layer serves as a cushion and the secondary coating layer serves as a blocker. Preferably, the primary coating layer is formed of a material having a lower modulus than that of the secondary coating layer. Also, the primary coating layer has a glass transition temperature Tg of −30° C. or less and the secondary coating layer has a glass transition temperature Tg of 50° C. or more. Accordingly, when a coating agent is exposed to ultraviolet rays, the primary coating layer is cured and becomes soft, while the secondary coating layer is cured and becomes hard. In particular, when the modulus requirement at room temperature for the primary coating layer less than 10 MPa and the modulus requirement at room temperature for the secondary coating layer within 50 MPa to 1000 MPa are satisfied, it is possible to provide softness suited to protect the glass core of the optical fiber at room temperature and to minimize the transmission loss under severe installation conditions in the residential district where bending stresses or tension of about 90 degrees is applied.

Preferably, the coating layer 103 has a degree of cure of 90% or more. In this instance, the cure characteristics are analyzed by general sol-gel analysis in which the optical fiber is cut into samples having a predetermined length, the sample is weighed out and dipped into a tetrahydrofuran (THF) solution of 80° C. capable of dissolving resin of the coating layer for 2 hours, the sample is weighed out again after resin of a non-cured coating layer is dissolved in the THF solution, and the degree of cure is analyzed through a weight difference before and after the dissolution of resin of the coating layer.

As described above, the bend-insensitive optical fiber 100 is provided with a region having a relatively low refractive index in the cladding 102, and has excellent bending characteristics and volume reduction (the outer diameter Dₐ of the coating layer 103 is 240 μm or less) by optimizing the modulus of the coating layer 103.

To reduce the optical loss of the optical fiber under bending conditions more effectively, it is preferred to satisfy the condition where a ratio r1/r2 is 1 to 1.5 in which the thickness of the primary coating layer is r1 and the thickness of the secondary coating layer is r2.

The bend-insensitive optical fiber 100 according to a preferred embodiment of the present invention has a stress corrosion parameter (Nd) of 18 or more and a bidirectional splice loss of 0.1 dB/km or less when measured at 1 μm/sec, 10 μm/sec, 100 μm/sec, and 1000 μm/sec by the two-point bending test in accordance with IEC 60793-1-33 standards.

Also, the bend-insensitive optical fiber 100 according to a preferred embodiment of the present invention has an increase in loss of 0.05 dB/km or less at a temperature between −60° C. and 85° C. relative to the room temperature and a multi-path interference (MPI) level of −30 dB or less at 1310 nm, 1550 nm, and 1625 nm wavelength.

The bend-insensitive optical fiber 100 described above may be manufactured by drawing an optical fiber preform produced by modified chemical vapor deposition (MCVD), followed by coating. In particular, when producing the optical fiber preform, a region, preferably a trench region having a lower refractive index than that of the cladding 102 is formed during the formation of the cladding 102, and during the coating, the outer diameter of the coating layer 103 is adjusted to 240 μm or less while optimizing the modulus of the coating layer 103.

As shown in (a) of FIG. 4, the present invention provides an optical cable including a sheath 200 and a plurality of the bend-insensitive optical fibers 100 inserted in the sheath 200. As shown in (b) of FIG. 4, the optical cable of the present invention has a reduction in total volume when compared with an optical cable 20 including a sheath 20 and the same number of conventional optical fibers 10 inserted in the sheath 20.

Specifically, the present invention can achieve a volume reduction of 20% per core and receive a greater number of cores 1.5 times or more in a certain microduct of the same size, when compared with the conventional optical fiber 10 having an outer diameter of a coating layer of 250 μm.

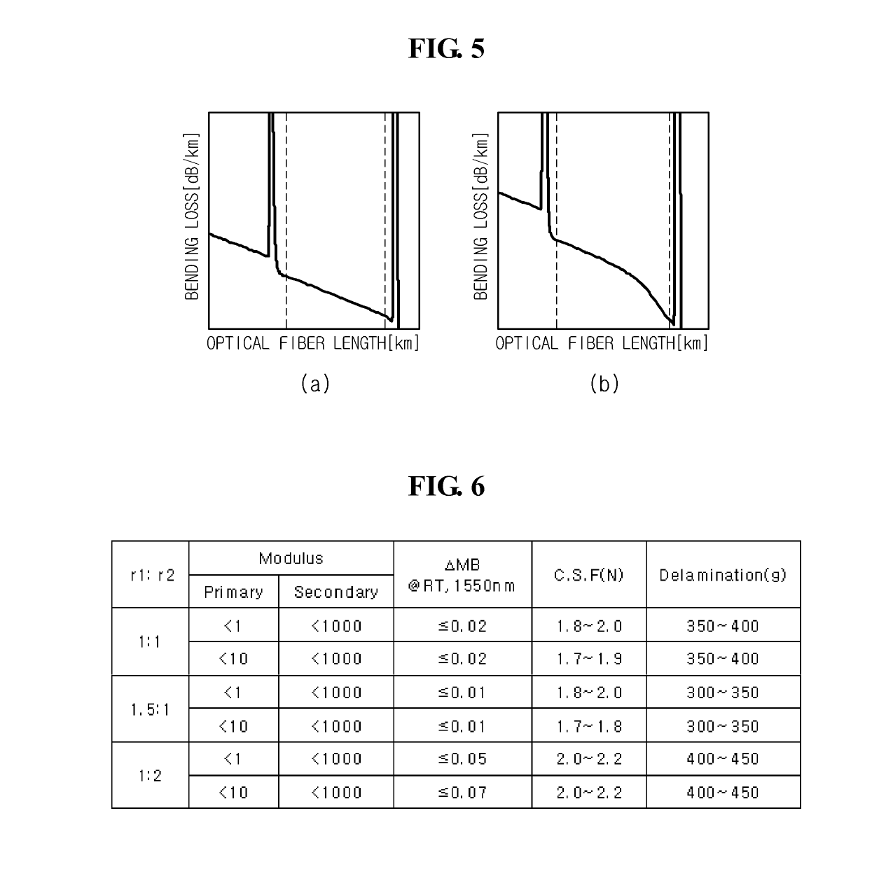

FIG. 5 is an optical-time domain reflectometer (OTDR) graph illustrating the transmission loss of a bend-insensitive optical fiber according to an exemplary embodiment of the present invention. In FIG. 5, each peak denotes a splice loss occurring at a starting end and a terminating end of an optical fiber to test, and the transmission loss characteristics of the optical fiber can be evaluated from the slope between two peaks.

The OTDR graph shown in (a) of FIG. 5 illustrates the loss at 1550 nm for an optical fiber having excellent microbending characteristics, and the OTDR graph shown in (b) of FIG. 5 illustrates the loss at 1550 nm for an optical fiber having poor bending characteristics. When bending stresses are applied to a specific area of an optical fiber carrying light, light escapes the optical fiber and the optical power reduces. In other words, the optical loss increases. This is an inflection point on the graph. When the outer diameter of the coating layer 103 reduces, the conventional optical fiber cannot prevent the external impacts, while the bend-insensitive optical fiber of the present invention has a small loss under the same bending conditions, as seen in (a) of FIG. 5. This is because the bend-insensitive optical fiber of the present invention has optimum material properties of the coating layer such as modulus, an optimum ratio of the thickness of the primary coating layer relative to the thickness of the secondary coating layers that is resistant to bending stresses, and a geometrical structure.

FIG. 6 is a table illustrating the microbending characteristics at room temperature and the mechanical characteristics, particularly, coating strip force (C.S.F) and delamination resistance, depending on the ratio r1:r2 and the modulus of the primary and secondary coating layers. In this instance, the same glass transition temperature Tg is applied. When r1:r2 is 1:1, and when the modulus of the primary coating layer is less than 10 MPa and the modulus of the secondary coating layer is less than 1000 MPa, a microbending loss of 0.02 dB/km or less at room temperature is achieved. When r1 increases, the microbending characteristics improve but the delamination characteristics deteriorate more severely than those of a conventional optical fiber having a 250 μm coating diameter. When r2 increases, the mechanical characteristics improve but the microbending characteristics rapidly deteriorate. Preferably, the delamination resistance is equal to or at least 80% of that of a conventional optical fiber having a 250 μm coating diameter. Provided that the delamination resistance of a conventional optical fiber is 400 g to 500 g, the other characteristics are at good levels when the delamination resistance is at least in the range of 300 g to 400 g.

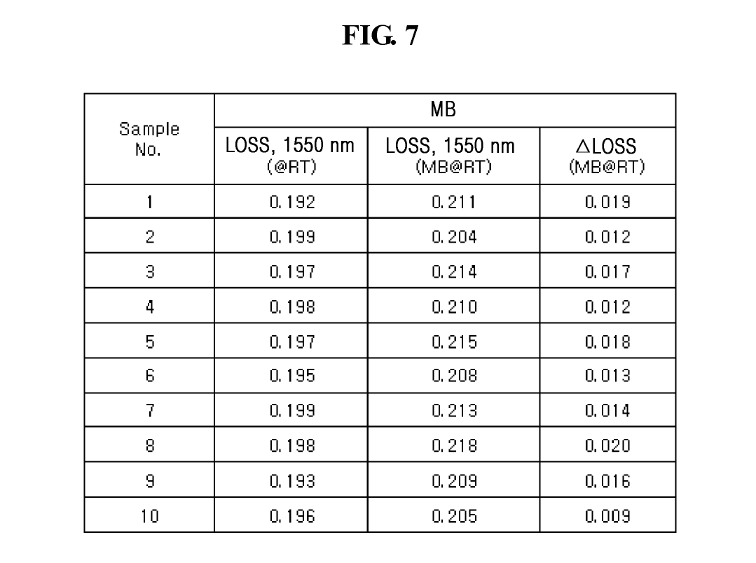

FIG. 7 is a table illustrating the microbending characteristics at room temperature for an optical fiber with a small coating diameter of 240 μm or less. A difference ΔMB in loss at 1550 nm at room temperature between a basket weave configuration and a loose wind configuration is 0.02 dB/km or less. Accordingly, it is found that the optical fiber with a small coating diameter of 240 μm or less ensures similar microbending characteristics to those of a conventional optical fiber having a 250 μm coating diameter.

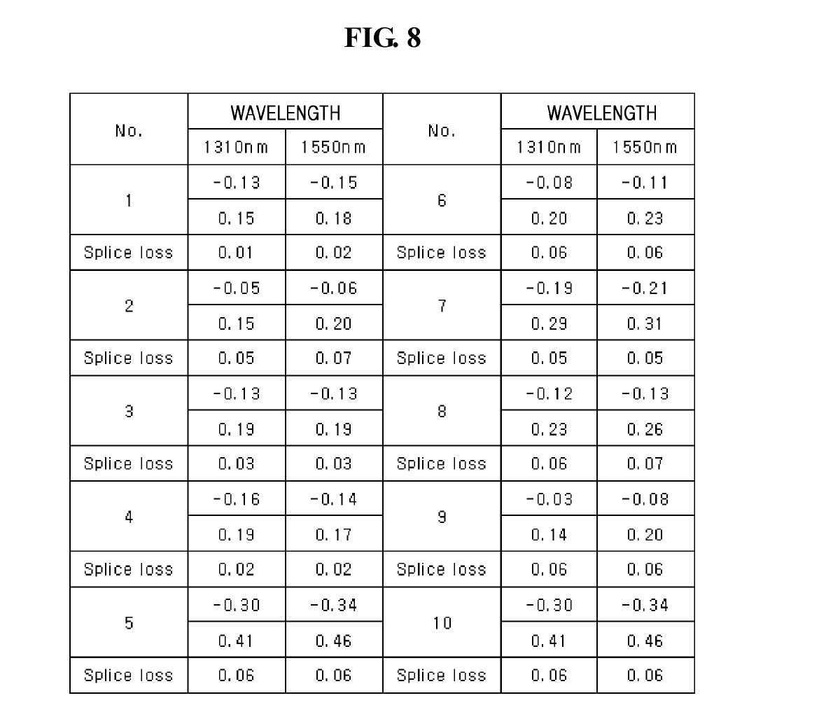

FIG. 8 is a table illustrating the bidirectional splice loss of an optical fiber with a small coating diameter of 240 μm or less. The optical fiber with a small coating diameter of 240 μm or less satisfies the bidirectional splice loss requirement of 0.1 dB/km or less at 1310 nm and 1550 nm wavelength. Accordingly, it is found that optical fiber with a small coating diameter of 240 μm or less ensures similar splice loss characteristics to those of a conventional optical fiber having a 250 μm coating diameter.

Hereinabove, the present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

The bend-insensitive optical fiber of the present invention can be effectively protected from external impacts while achieving the volume reduction, and minimize the transmission loss under severe installation conditions in the residential district where bending stresses or tension of about 90 degrees is applied.

1. A bend-insensitive optical fiber comprising:
a core centered at the optical fiber;
a cladding surrounding the core and having a lower refractive index than the core;
a coating layer surrounding the cladding; and
a region formed in the cladding and having a lower refractive index than the cladding,
wherein the coating layer includes a primary coating layer formed on the cladding and a secondary coating layer formed on the primary coating layer and having a higher modulus than the primary coating layer, and the coating layer has a total outer diameter of 240 μm or less,
the primary coating layer has a modulus of 10 MPa or less at room temperature and the secondary coating layer has a modulus of 50 to 1000 MPa at room temperature, and
the coating layer has a degree of cure of 90% or more measured by sol-gel analysis.

2. A bend-insensitive optical fiber comprising:
a core centered at the optical fiber;
a cladding surrounding the core and having a lower refractive index than the core;
a coating layer with a multilayered structure surrounding the cladding and having a total outer diameter of 240 μm or less; and
a region formed in the cladding and having a lower refractive index than the cladding,
wherein the optical fiber has a microbending loss of 0.02 dB/km or less at 1550 wavelength at room temperature, measured by basket weave testing,
the optical fiber has a bidirectional splice loss of 0.1 dB/km or less,
the optical fiber has a stress corrosion parameter (Nd) of 18 or more, and
the optical fiber has an increase in loss of 0.05 dB/km or less at a temperature between −60° C. and 85° C. relative to room temperature.

3. A bend-insensitive optical fiber comprising:
a core centered at the optical fiber;
a cladding surrounding the core and having a lower refractive index than the core;
a coating layer surrounding the cladding; and
a region formed in the cladding and having a lower refractive index than the cladding,
wherein the coating layer has a multilayered structure and a total outer diameter of 240 μm or less.

4. The bend-insensitive optical fiber according to claim 3,
wherein the coating layer has an outer diameter of 200 to 240 μm.

5. The bend-insensitive optical fiber according to claim 4,
wherein the coating layer includes a primary coating layer formed on the cladding and a secondary coating layer formed on the primary coating layer and having a higher modulus than the primary coating layer.

6. The bend-insensitive optical fiber according to claim 5,
wherein the primary coating layer has a modulus of 10 MPa or less at room temperature, and the secondary coating layer has a modulus of 50 to 1000 MPa at room temperature.

7. The bend-insensitive optical fiber according to claim 5,
wherein a ratio of r1/r2 is 1 to 1.5 where r1 is the thickness of the primary coating layer and r2 is the thickness of the secondary coating layer.

8. The bend-insensitive optical fiber according to claim 5,
wherein the primary coating layer has a glass transition temperature Tg of −30° C. or less and the secondary coating layer has a glass transition temperature Tg of 50° C. or more.

9. The bend-insensitive optical fiber according to claim 5,
wherein the optical fiber has a microbending loss of 0.02 dB/km or less at 1550 nm wavelength at room temperature, measured by basket weave testing.

10. The bend-insensitive optical fiber according to claim 5,
wherein the coating layer has a degree of cure of 90% or more by sol-gel analysis.

11. The bend-insensitive optical fiber according to claim 5,
wherein the optical fiber has a stress corrosion parameter (Nd) of 18 or more.

12. The bend-insensitive optical fiber according to claim 5,
wherein the optical fiber has a bidirectional splice loss of 0.1 dB/km or less.

13. The bend-insensitive optical fiber according to claim 5,
wherein the optical fiber has an increase in loss of 0.05 dB/km or less at a temperature between −60° C. and 85° C. relative to room temperature.

14. The bend-insensitive optical fiber according to claim 5,
wherein the optical fiber has a multi-path interference (MPI) level of −30 dB or less at 1310 nm, 1550 nm, and 1625 nm wavelength.

15. A bend-insensitive optical cable comprising a bend-insensitive optical fiber according to claim 3.
